(19) United States
(12) Patent Application Publication
(10) Pub. No.: US 2016/0073051 A1
(43) Pub. Date: Mar. 10, 2016

(54) DRIVING RECORDER AND DRIVING RECORDING METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: WEI-FENG WU, Shenzhen (CN)

(21) Appl. No.: 14/560,111

(22) Filed: Dec. 4, 2014

(30) Foreign Application Priority Data
Sep. 9, 2014 (CN) 201410454681.9

(51) Int. Cl. H04N 5/91; H04N 5/77; G06K 9/00

(52) U.S. Cl. CPC H04N 5/91; G06K 9/00791; H04N 5/77; H04W 84/12

(57) ABSTRACT

A driving recorder of a vehicle includes a video module, a processing module electrically connected to the video module; a display module, an audio module, a Wi-Fi antenna module, and an input module electrically connected to the processing module. The processing module is configured to receive data and process the received data. The Wi-Fi antenna module includes a first unidirectional antenna and a second unidirectional antenna. The first unidirectional antenna is configured to receive a Wi-Fi signal in front of the vehicle and emit a Wi-Fi signal to the front of the vehicle. The second unidirectional antenna is configured to receive a Wi-Fi signal from behind the vehicle and emit a Wi-Fi signal towards the back. The input module is configured to selectively transmit data to the processing module.

### FIELD

The subject matter herein generally relates to a driving recorder for a vehicle.

### BACKGROUND

A driving recorder for a vehicle can automatically record a scene outside or inside a vehicle while operation of the vehicle. This recording can be utilized as an accident recording system and can be issued as evidence in case of an accident.

### BRIEF DESCRIPTION OF THE DRAWINGS

Implementations of the present technology will now be described, by way of example only, with reference to the attached figures.

FIG. 1 is a diagrammatic view of a driving recorder according to an embodiment of the present disclosure.

FIG. 2 is a flow chart of a process for a driving recording method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The connection can be such that the objects are permanently connected or releasably connected. The term “outside” refers to a region that is beyond the outermost confines of a physical object. The term “inside” indicates that at least a portion of a region is partially contained within a boundary formed by the object. The term “comprising”, when utilized, means “including, but not necessarily limited to”; it specifically indicates open-ended inclusion or membership in the so-described combination, group, series and the like.

The present disclosure is described in relation to a driving recorder and a driving recording method.

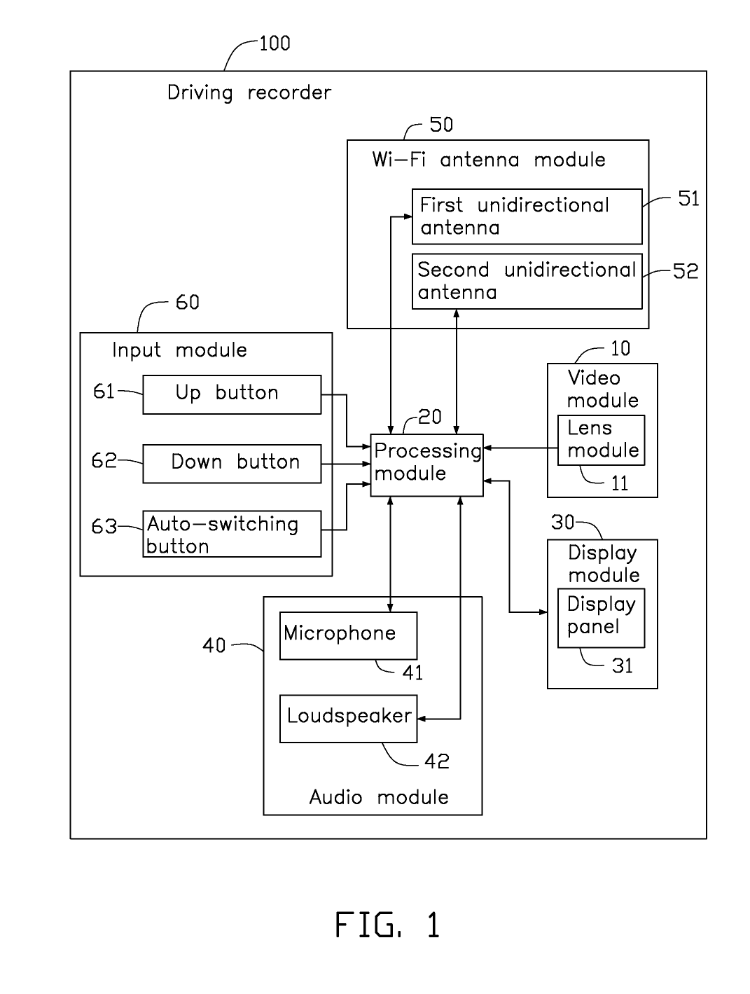

FIG. 1 illustrates a driving recorder 100 according to an embodiment of the present disclosure. The driving recorder 100 can include a video module 10, a processing module 20, a display module 30, an audio module 40, a Wi-Fi antenna module 50, and an input module 60. The processing module 20 can be electrically connected to the video module 10, the display module 30, the audio module 40, the Wi-Fi antenna module 50, and the input module 60

The driving recorder 100 can be mounted on a vehicle and the video module 10 can be configured to record scenes while operation of the vehicle. The video module 10 can include a lens module 11 rotatably installed on the vehicle. The lens module 11 can be configured to automatically rotate toward the inside or the outside of the vehicle. Data of the scenes recorded by the video module 10 can be transmitted to the processing module 20.

The processing module 20 can collect and process the data from the video module 10. The data processed by the processing module 20 can be further transmitted to the display module 30 and the audio module 40. In addition, the processing module 20 can further collect and process data from the audio module 40, the Wi-Fi antenna module 50, and the input module 60.

The display module 30 can include a display panel 31. The display module 30 can be configured to receive the data from the processing module 20 and can display images according to data from the processing module 20. The display panel 31 can issue a touch signal by a touch operation. The touch signal issued by the display module 31 can be transmitted to the processing module 20 and can be processed by the processing module 20. The processed data from the processing module 20 can be further transmitted to the Wi-Fi antenna module 50 and can be emitted outside via the Wi-Fi antenna module 50.

The audio module 40 can include a microphone 41 and a loudspeaker 42 electrically connected to the processing module 20. The audio module 40 can receive the processed data from the processing module 20 and can further display a video according to the received data. At the same time, voices inside the vehicle can be transmitted to the processing module 20 via the audio module 40 to be processed. Processed data of the voices then can be transmitted to Wi-Fi antenna module 50 and further emitted outside via the Wi-Fi antenna module 50.

The Wi-Fi antenna module 50 can include a first unidirectional antenna 51 and a second unidirectional antenna 52. The first unidirectional antenna 51 can be configured to receive a Wi-Fi signal from a front of the vehicle and emit a Wi-Fi signal toward the front of the vehicle. The second unidirectional antenna 52 can be configured to receive a Wi-Fi signal behind the vehicle and emit a Wi-Fi signal toward the back of the vehicle. As the first unidirectional antenna 51 and the second unidirectional antenna 52 are unidirectional, the Wi-Fi signals emitted by the first unidirectional antenna 51 and second unidirectional antenna 52 cannot interfere with each other.

The input module 60 can include an up button 61, a down button 62, and an auto-switching button 63. The input module 60 can selectively transmit signals to the processing module 20. The processing module 20 can selectively transmit data to the first unidirectional antenna 51 or the second unidirectional antenna 52, according to the signals received from the input module 60. When the first unidirectional antenna 51 receives the data from the input module 60, the first unidirectional antenna 51 can be selected to be controlled by the processing module 20 to receive or to emit signals. When the second unidirectional antenna 52 receives the data from the input module 60, the second unidirectional antenna 52 can be selected to be controlled by the processing module 20 to receive or to emit signals.

When the up button 61 of a vehicle 1 is activated, a signal can be emitted to the processing module 20 to control the first unidirectional antenna 51 of the vehicle 1 to receive a Wi-Fi signal emitted by the second unidirectional antenna 52 of vehicle 2 in front of vehicle 1. Thus, a real-time recording of vehicle 2 can be employed by the first unidirectional antenna 51 of vehicle 1. However, if vehicle 2 does not exist in front of vehicle 1, the second unidirectional antenna 52 of vehicle 1 can label signals to be emitted as abnormal signals and emit the labeled signals to the back.

If more than one vehicle, for example including the vehicle 2, a vehicle 3 in front of vehicle 2, a vehicle 4 in front of vehicle 3 exist in front of vehicle 1, the up button 61 of vehicle 1 can be given a repeated operation. When the up button 61 of vehicle 1 is repetitively activated several times, the first unidirectional antenna 51 can successively receive real-time data recorded by vehicle 3 in front of vehicle 2. At the same time, the received data can further be transmitted from the first unidirectional antenna 51 to the processing module 20 and the processing module 20 can successively receive and process the received data from the first unidirectional antenna 51. The processed data can be transmitted to the display module 30 and the audio module 40 from the processing module 20. The display module 30 can display real-time images and the audio module 40 can play back the real-time audio. When an operator continually activates the up button 61 of vehicle 1, real-time scenes recorded by vehicle 4 in front of vehicle 3 can be successively switched to be viewed by the operator of vehicle 1.

When the down button 62 of vehicle 4 is operated, a signal can be emitted to the processing module 20 to control the second unidirectional antenna 52 of vehicle 4 to receive a Wi-Fi signal emitted by the first unidirectional antenna 51 of vehicle 3. Thus, the real-time data recording by vehicle 3 can be employed by the second unidirectional antenna 52 of vehicle 4. When the down button 62 of vehicle 4 is repetitively activated several times, the second unidirectional antenna 52 can successively receive the real-time data recorded by all vehicles behind vehicle 4, for example vehicle 2, and vehicle 1. At the same time, the received data can be further transmitted from the second unidirectional antenna 52 to the processing module 20 and the processing module 20 can receive and process the received data. The processed data from the processing module 20 can be transmitted to the display module 30 and the audio module 40. Thus, real-time scenes behind vehicle 4 can be successively switched to be viewed by the operator of vehicle 4.

When the first unidirectional antenna 51 of vehicle 1 does not receive a Wi-Fi signal emitted by the second unidirectional antenna 52 of vehicle 2, the auto-switching button 63 can automatically issue signals to the first unidirectional antenna 51 to control the first unidirectional antenna 51 to receive the labeled abnormal signals from the second unidirectional antenna 52 of vehicle 2. The received labeled abnormal signals can be transmitted to the processing module 20 and be processed by the processing module 20. The processed data can be received by the display module 30 and the audio module 40. The display module 30 can thus display images and the audio module 40 can thus play audio. Real-time scenes such as a scene of accident or traffic light in front of vehicle 2 which emits the abnormal signals can be easily recognized by the operator of vehicle 1.

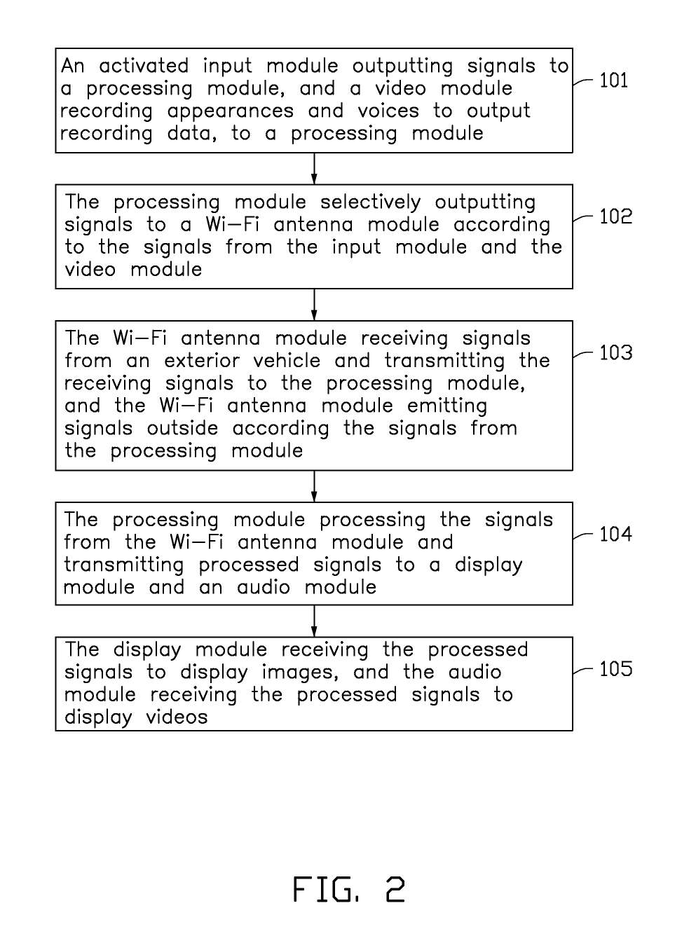

FIG. 2 illustrates a flow chart of a process for a driving recording method of the present disclosure. In block 101, the input module 60 can be pressed and signals can be selectively transmitted from the input module 60 to the processing module 20. At the same time, scenes can be recorded by the video module 10 and recorded data of the scenes can be transmitted to the processing module 20 from the video module 10.

In block 102, signals can be issued by the processing module 20 according to the signals from the input module 60 and the video module 10, and the issued signals from the processing module 20 can be further transmitted to the Wi-Fi antenna module 50.

In block 103, the Wi-Fi antenna module 50 can be activated by the received signals from the processing module 20, and signals from other vehicles can be selectively received by the Wi-Fi antenna module 50 which can be transmitted to the processing module 20. At the same time, the signals from the video module 10 to the processing module 20 can be processed by the processing module 20 and transmitted selectively to other vehicles.

In block 104, the signals from the Wi-Fi antenna module 50 can be processed by the processing module 20, and the processed signals from the processing module 20 can be transmitted to the display module 30 and the audio module 40.

In block 105, images and videos can be played by the display module 30 and played by the audio module 40 according to the processed signals from the processing module 20.

In other embodiments, in block 101, one of the up buttons 61, the down button 62, or the auto-switching button 63 can be activated and can transmit signals to the processing module 20.

In one embodiment, in block 102, signals can be transmitted to the first unidirectional antenna 51 of vehicle 1 from the processing module 20 according to the signals from the up button 61 of vehicle 1, and a Wi-Fi signal emitted by the second unidirectional antenna 52 of vehicle 2 can be received by the first unidirectional antenna 51 of vehicle 1.

In one embodiment, in block 102, signals can be transmitted from the processing module 20 to the second unidirectional antenna 52 of vehicle 4 according to the signals from the down button 62 of vehicle 4, and a Wi-Fi signal emitted by the first unidirectional antenna 51 of vehicle 3 can be received by the second unidirectional antenna 52 of the vehicle 4.

In other embodiments, in block 102, the labeled abnormal signals from the second unidirectional antenna 52 of the vehicle 2 can be received by the processing module 20 according to the signals from the auto-switching button 63 of vehicle 1.

In operation, in a situation where vehicle 1 is on a two-way street and is overtaking vehicle 2 driving on the same side in front of vehicle 1, however, a visibility range of vehicle 1 is obstructed by the vehicle 2. A collision may occur, if the vehicle 1 overtakes the vehicle 2 in front without clear visibility. In this situation, the up button 61 of vehicle 1 can be activated, and the input module 60 can transmit signals to the processing module 20. The processing module 20 can select and control the first unidirectional antenna 51 according to the signals from the input module 60. The first unidirectional antenna 51 of vehicle 1 can receive a Wi-Fi signal from the second unidirectional antenna 52 of vehicle 2. Thus, vehicle 1 can receive the real-time data recorded by vehicle 2 in front. Then, the Wi-Fi signal received by the first unidirectional antenna 51 can be further transmitted to the processing module 20 to be processed. The display module 30 and the audio module 40 can receive the processed signal from the processing module 20. The display module 30 can display images and the audio module 40 can play audio. The driver of vehicle 1 can thus have a clear visibility of the scene in front of vehicle 2, and determine whether overtaking vehicle 2 is safe.

If the driver does not have clear visibility in front of vehicle 2 to overtake vehicle 2 after one operation of the up button 61, the up button 61 of vehicle 1 can receive repeated operations until the driver has a clear visibility.

In a second situation that a traffic jam occurs as drivers wait for a traffic light, an accident or the like, several vehicles behind the jam may get anxious or worry. In this situation, the vehicle 4 adjacent to the traffic light or the accident does not receive a normal Wi-Fi signal from the second unidirectional antenna 52 of a vehicle, and the second unidirectional antenna 52 of vehicle 4 can emit labeled abnormal signals toward the back. Thus, the first unidirectional antenna of a vehicle 3 in the back of the vehicle 4 can receive the labeled abnormal signals. The auto-switching button 63 of vehicle 3 can be activated and the input module 60 can transmit a signal to the processing module 20. The processing module 20 can automatically determine that vehicle 4 is adjacent to the traffic light or the accident. The display module 30 and the audio module 40 can be controlled by the processing module 20 to display images and audio of the traffic light or the accident. The driver can reduce anxiety after viewing the visibility range before the first vehicle.

In other situations, the lens module 11 can rotate toward inside a vehicle to record videos; the drivers in two vehicles can communicate with each other by a video call via a portable electric device connected to the Wi-Fi antenna module 50. The drivers in different vehicles can also have video calls via the video module 10, processing module 20, display module 30, audio module 40 and Wi-Fi antenna module 50 of their own driving recorder 100 without using a portable electric device.

The embodiments shown and described above are only examples. Many details are often found in the art such as the other features of a driving recorder and driving recording method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A driving recorder, positioned on a vehicle, comprising:
a video module to record video during operation of the vehicle;
a processing module electrically connected to the video module, the processing module configured to receive data and process the data received;
a display module electrically connected to the processing module;
an audio module electrically connected to the processing module;
a Wi-Fi antenna module electrically connected to the processing module, the Wi-Fi antenna module having a first unidirectional antenna configured to receive a Wi-Fi signal from a front of the vehicle and emit a Wi-Fi signal toward the front of the vehicle; and the Wi-Fi antenna having a second unidirectional antenna configured to receive a Wi-Fi signal behind the vehicle and emit a Wi-Fi signal toward a back of the vehicle;
an input module electrically connected to the processing module, and configured to selectively transmit data to the processing module.

2. The driving recorder as claimed in claim 1, wherein the video module includes a lens module which is capable of automatically rotating toward inside or outside the vehicle.

3. The driving recorder as claimed in claim 1, wherein the audio module includes a microphone and a loudspeaker.

4. The driving recorder as claimed in claim 1, wherein the input module includes an up button configured to transmit signals to the processing module to control the first unidirectional antenna of the vehicle to receive a Wi-Fi signal emitted by the second unidirectional antenna of a vehicle in front.

5. The driving recorder as claimed in claim 1, wherein, the input module further includes a down button configured to transmit signals to the processing module to control the second unidirectional antenna to receive a Wi-Fi signal emitted by the first unidirectional antenna of a vehicle behind.

6. The driving recorder as claimed in claim 1, wherein, the second unidirectional antenna of a first forward vehicle can label signals as abnormal signals and emit the labeled signals backward when no vehicles exists before the vehicle in front.

7. The driving recorder as claimed in claim 6, wherein, the input module further includes an auto-switching button configured to transmit signals to the processing module to further control the first unidirectional antenna of the vehicle to receive the labeled signals.

8. A driving recording method for a driving recorder positioned on a vehicle, comprising:
an activated input module outputting signals to a processing module, and a video module recording appearances and voices to output recording data, to a processing module;
the processing module selectively outputting signals to a Wi-Fi antenna module according to the signals from the input module and the video module;
the Wi-Fi antenna module receiving signals from an exterior vehicle and transmitting the receiving signals to the processing module, and the Wi-Fi antenna module emitting signals outside according the signals from the processing module;
the processing module processing the signals from the Wi-Fi antenna module and further transmitting processed signals to a display module and an audio module;
the display module receiving the processed signals to display images, and the audio module receiving the processed signals to display audio.

9. The driving recording method as claimed in claim 8, wherein,
the input module includes an up button, a down button and an auto-switching button; and
the Wi-Fi antenna module includes a first unidirectional antenna and a second unidirectional antenna.

10. The driving recording method as claimed in claim 9, wherein, if the up button is activated, signals can be output to the processing module to control the first unidirectional antenna to receive signals from an exterior vehicle.

11. The driving recording method as claimed in claim 9, wherein, if the down button is activated, signals can be output to the processing module to control the second unidirectional antenna to receive signals from an exterior vehicle.

12. The driving recording method as claimed in claim 9, wherein, if no vehicles exist before the vehicle, the second unidirectional antenna of the vehicle can label signals as abnormal signals and emit the labeled signals to a back of the vehicle.

13. The driving recording method as claimed in claim 12, wherein, if the auto-switching button is activated, signals can be output to the processing module to control the first unidirectional antenna of the vehicle to receive the labeled abnormal signals.
